(19) United States
(12) Patent Application Publication
(10) Pub. No.: US 2013/0141267 A1
(43) Pub. Date: Jun. 6, 2013

(54) REMOTE OPERATION DEVICE

(71) Applicant: Shozo HORISAWA, Chiba (JP)

(72) Inventor: Shozo HORISAWA, Chiba (JP)

(21) Appl. No.: 13/342,662

(22) Filed: Jan. 3, 2012

(30) Foreign Application Priority Data
Dec. 1, 2011 (JP) P2011-004271

(51) Int. Cl. G08C 19/12

(52) U.S. Cl. 341/176

(57) ABSTRACT

A remote operation device includes a main board housed in a casing of the remote operation device, a wireless communication module disposed on a first surface of the main board and including an antenna, a control circuit disposed on the first surface of the main board and performing a remote operation process through wireless communication, at least one ground pattern disposed on a second surface of the main board, and a matrix circuit of remote operation keys disposed on the second surface of the main board.

### BACKGROUND

The present disclosure relates to a remote operation device that is used to remotely operate an apparatus to be controlled, such as a television set and, in particular, to a remote operation device which conducts two-way communication with the apparatus to be controlled over a wireless network.

Nowadays, remote control systems including a remote controller are widely applied to TV sets, audio-visual apparatuses, and many other information processing apparatuses.

A typical remote control system conducts communication by means of infrared rays. Such an infrared communication system can be constructed at a low cost, but the communication is limited to a single direction and the communication area is restricted due to the directivity of infrared rays. Another type of remote control system employs a radio frequency (RF) communication scheme and conducts communication over a wireless network. Such an RF remote control system enables two-way communication with the host apparatus, and the communication area is relatively wide.

Zigbee RF4CE (referred to as “RF4CE” hereinafter) is the standard specification of a remote control function that is defined mainly for consumer electronic (CE) products. The interface of the PHY/MAC layer in RF4CE employs IEEE (Institute of Electrical and Electronic Engineers) 802.15.4. IEEE 802.15.4 defines operation in the same frequency band (2.4 GHz) as the Wireless Local Area Network (WLAN) specification IEEE 802.11b, and this frequency band is divided into sixteen channels.

Japanese Unexamined Patent Application Publication No. 2009-267560 has proposed a remote control system which employs the wireless network defined by IEEE 802.15.4 enabling a remote control operation to be performed while avoiding interference.

Moreover, Japanese Unexamined Patent Application Publication No. 2009-141786 has proposed a remote operation device that is used to remotely operate an electronic apparatus over the wireless network defined by IEEE 802.15.4. In addition, this device is equipped with a reader/writer for an IC card, and the IC card is applied to a process performed by the electronic apparatus.

A typical RF remote controller is provided with an RF circuit module including an antenna, and this module is mounted on a sub board, which is independent of the main board on which a circuit for performing a remote control operation is mounted. Furthermore, an IC card reader/writer circuit module is also mounted on a sub board (refer to Japanese Unexamined Patent Application Publication No. 2009-141786). When the RF circuit module is mounted on a sub board, the remote controller has an advantage as this module can be developed and designed separately from the main board, or can be supplied by an appropriate vender. Meanwhile, the disadvantage is that the system and process for distributing the remote controller are complex, because it is necessary to convey the sub boards to the manufacturing line of the main boards. Moreover, additional components such as connectors or cables for connecting the main board and the sub board are necessary, causing an increase in component cost. Furthermore, the additional process of attaching a sub board to the main board increases manufacturing cost, and the space occupied by the sub board results in an enlargement of the remote controller.

### SUMMARY

There is a need for a high-performance remote operation device capable of appropriately conducting two-way communication with an apparatus to be controlled over a wireless network.

In addition, there is a need for a low-cost high-performance remote operation device having a wireless communication function.

Furthermore, there is a need for a low-cost high-performance remote operation device capable of having both wireless communication and IC card reader/writer functions.

According to an embodiment of the present disclosure, there is provided a remote operation device including a main board, a wireless communication module, a control circuit, at least one ground pattern, and a matrix circuit. Specifically, the main board is disposed in a casing of the remote operation device. The wireless communication module is disposed on a first surface of the main board, and includes an antenna. The control circuit is disposed on the first surface of the main board, and performs a remote operation process through wireless communication. The ground pattern is disposed on a second surface of the main board. The matrix circuit of remote operation keys is disposed on the second surface of the main board.

According to an embodiment of the present disclosure, the remote operation device further includes a contactless communication module disposed on the first surface of the main board, and the contactless communication module includes an antenna.

According to an embodiment of the present disclosure, in the remote operation device, the antenna of the wireless communication module includes a balanced or unbalanced antenna made of at least one pattern formed on the first surface of the main board.

According to an embodiment of the present disclosure, in the remote operation device, the antenna of the wireless communication module is a diversity antenna including two dipole antenna elements made of patterns formed on the first surface of the main board.

According to an embodiment of the present disclosure, in the remote operation device, the control circuit performs both the remote operation process and a process of an upper protocol layer during the wireless communication conducted by the wireless communication module including the antenna.

According to an embodiment of the present disclosure, in the remote operation device, the ground pattern disposed on the second surface of the main board is limited to a ground pattern for a high frequency circuit portion of the wireless communication module.

According to an embodiment of the present disclosure, in the remote operation device, the main board includes, on the second surface, a solder resist layer and carbon electrode patterns for switches of the remote operation keys. Furthermore, the solder resist layer is formed on the second surface of the main body on which the ground pattern and the matrix circuit of the remote operation keys are formed, and the carbon electrode patterns are formed on the solder resist layer.

The present disclosure makes it possible to provide a low-cost high-performance remote operation device having a wireless communication function.

Furthermore, the present disclosure makes it possible to provide a low-cost high-performance remote operation device having both wireless communication and IC card reader/writer functions.

In the remote operation device according to an embodiment of the present disclosure, the wireless communication module including the antenna and the contactless communication module including the antenna are mounted on the main board where a circuit for performing the remote control operation is mounted. This makes it possible to manufacture the remote operation device at a low cost and to make the device thin.

Other features and advantages of the present disclosure will become apparent upon reading the following embodiment of the present disclosure and detailed explanation when taken in conjunction with the accompanying drawings.

### BRIEF DESCRIPTION OF THE DRAWINGS

FIG. 1 is a schematic view depicting a configuration of an RF remote control system according to an embodiment of the present disclosure;

FIG. 2 is view depicting an exemplary functional structure of a remote controller in the RF remote control system;

FIG. 3 is a schematic view of a layout of circuit modules shown in FIG. 2 which constitute the remote controller and which are arranged on a main board;

FIG. 4 is an exemplary view depicting circuit patterns on a surface of the main board shown in FIG. 3;

FIG. 5 is an exemplary view depicting circuit patterns on the opposite surface of the main board; and

FIG. 6 is a schematic view depicting a sectional structure of the main board.

### DETAILED DESCRIPTION OF EMBODIMENTS

An embodiment of the present disclosure will be described below in detail with reference to the accompanying drawings.

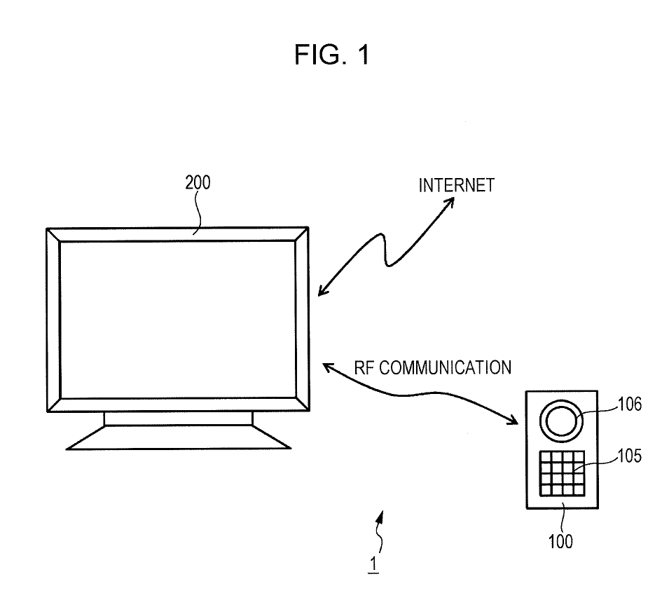

FIG. 1 schematically shows a configuration of an RF remote control system 1. This remote control system 1 includes a remote operation device (referred to as “remote controller”) 100 and a TV set 200. The TV set is an example of an electrical apparatus which conducts wireless communication with the remote controller 100.

The remote controller 100 has a key operation function implemented by an array of operation keys for inputting operation signals in accordance with user's operation for the TV set 200. Also, the remote controller 100 has a reader/writer function for reading or writing information from or to an IC card (not shown).

The TV set 200 has the functions of a typical TV set. In addition, the TV set 200 may have a function of connecting to the Internet to download or reproduce contents such as movies, cartoons, dramas, sports, or games supplied from a service provider over the Internet.

The communication between the remote controller 100 and the TV set 200, including the transmitting of remote control codes, is conducted in accordance with the RF4CE specification. This enables two-way communication using RF signals in the 2.4 GHz frequency band.

A reader/writer in the remote controller 100 emits a continuous wave, thereby reading or writing information from or to an IC card in a contactless manner. An IC card may store information including electronic money to be used for payment upon purchase of contents, a PIN number or password for accessing an electrical apparatus, and authentication information. Furthermore, the reader/writer may read the authentication information or valued information from an IC card and use this information. For example, a user may pay for a chargeable content through the reader/writer by placing an IC card adjacent to the remote controller 100.

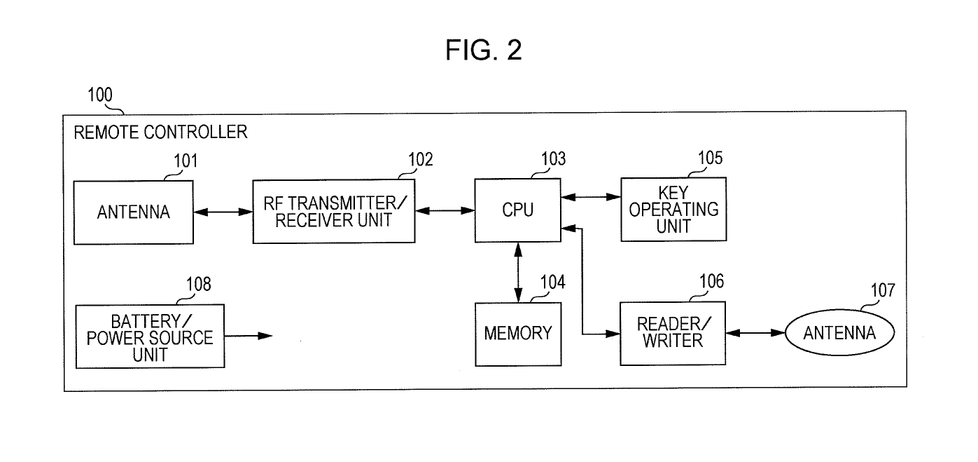

FIG. 2 shows an example of a functional structure of the remote controller 100. This remote controller 100 includes an antenna 101, an RF transmitter/receiver unit 102, a CPU 103, a memory 104, a key operating unit 105, a reader/writer 106, an antenna 107 and a battery/power source unit 108. Specifically, the antenna 101 is configured to establish wireless communication with the TV set 200. The RF transmitter/receiver unit 102 is configured to transmit or receive RF signals through the antenna 101. The memory 104 is connected to the CPU 103. The reader/writer 106 is configured to read or write information from or to an IC card. The antenna 107 is configured to electromagnetically interact with the IC card. The battery/power source unit 108 is configured to supply electricity to the individual modules.

The reader/writer 106 electromagnetically couples the antenna 107 and the antenna of the IC card (not shown) in accordance with the electromagnetic induction scheme using electromagnetic waves of 13.56 MHz that is applied to RFID. Then, the reader/writer 106 transmits or receives signals to or from the IC card. Specifically, the remote controller 100 feeds a current to the antenna 107, thereby generating an AC magnetic field at an information reading portion of the remote controller 100. Subsequently, once a user places an IC card adjacent to the information reading portion, an AC voltage is induced in the antenna coil of the IC card. This AC voltage is converted into a DC voltage in the IC card, which operates the IC chip therein. When a current flows through the antenna of the IC card, a magnetic field is generated around this antenna and influences the antenna 107 of the remote controller 100. This communication scheme conforms with an international standard applied to RFID, such as ISO/IEC IS 18092 (NFC IP-1). This scheme enables secure data transmission between a reader/writer device and an IC card at a distance of zero to several hundred millimeters.

The key operating unit 105 is provided with an array of operation keys. These keys include, for example, channel selection keys, volume adjustment keys, and a decision key, and an user operates the keys to enter remote control codes for the TV set 200.

The memory 104 includes a random access memory (RAM) and a read only memory (ROM). The CPU 103 reads program stored in the ROM of the memory 104, expands this program in the RAM, and executes the program. Consequently, the CPU 103 controls all signal processes in the remote controller 100. It should be noted that the functions of the CPU 103 and the memory 104 may be implemented on a single microcomputer chip.

The RF transmitter/receiver unit 102 mainly performs the process of the PHY/MAC layer in RF4CE through the antenna 101. Under control of the CPU 103, the RF transmitter/receiver unit 102 transmits, to the TV set 200, remote control codes for volume adjustment, channel switching, etc. Also, the RF transmitter/receiver unit 102 writes or reads information to or from an IC card. Even if data to be read or written from or to an IC card is of large volume, the remote controller 100 can transmit or receive this data through wireless communication at a high speed.

The battery/power source unit 108 is provided with a battery for driving the remote controller 100, and a power source for supplying a current to the reader/writer 106 in order to read or write information from or to an IC card.

It should be noted that the structure of the TV set 200 is not related to main points of the present disclosure directly, and therefore, the description thereof will be omitted herein.

When a user operates the TV set 200 by using the key operating unit 105 of the remote controller 100 so as to, for example, adjust the volume or switch the channel, the CPU 103 of the remote controller 100 transmits a remote control code in accordance with the user's operation for the TV set 200 through the RF transmitter/receiver unit 102 and the antenna 101.

When purchasing contents over the Internet, the user operates the key operating unit 105 of the remote controller 100 while viewing the operation screen displayed on the TV set 200. Following this, the user selects and decides on the content to be purchased.

For example, when the user selects and decides on the payment for a content by usage of an IC card, the TV set 200 remotely transmits, to the remote controller 100, an instruction for communication with the IC card. In response, the CPU 103 of the remote controller 100 turns on the reader/writer 106, and the reader/writer 106 then reads information stored in the IC card by emitting an electromagnetic wave from the antenna 107. The CPU 103 transmits the information read from the IC card to the TV set 200 through the RF transmitter/receiver unit 102 and the antenna 101. Moreover, the TV set 200 remotely transmits information to the remote controller 100, thereby allowing the CPU 103 to read or write information from or to the IC card. As a result, the payment process using an IC card is completed. Finally, the CPU 103 turns off the reader/writer 106.

As described above, the remote controller 100 has two communication functions, namely, a wireless communication function implemented by the antenna 101 and the RF transmitter/receiver unit 102, and a contactless communication function implemented by the antenna 107 and the reader/writer 106. In a typical remote controller, both a circuit module for wireless communications (referred to as “wireless communication module” hereinafter) including an antenna and a circuit module for contactless communications (referred to as “contactless communication module” hereinafter) including an antenna are mounted on a sub board, independent of the main board on which a circuit for performing a remote control operation is mounted. As mentioned before, such a sub board can be problematic, because the sub board leads to complexity of the distribution process and system, an increase in the manufacturing and component's costs, and enlargement of the remote controller. In consideration of these disadvantages, the present inventor has proposed that both the wireless communication module including an antenna and the contactless communication module including an antenna be mounted on a main board, so that the overall cost is reduced and the remote controller is reduced in size.

Hereinafter, a description will be given below in detail, of an example of a remote controller in which both a wireless communication module including an antenna and a contactless communication module including an antenna are arranged on the main board for performing the remote control operation.

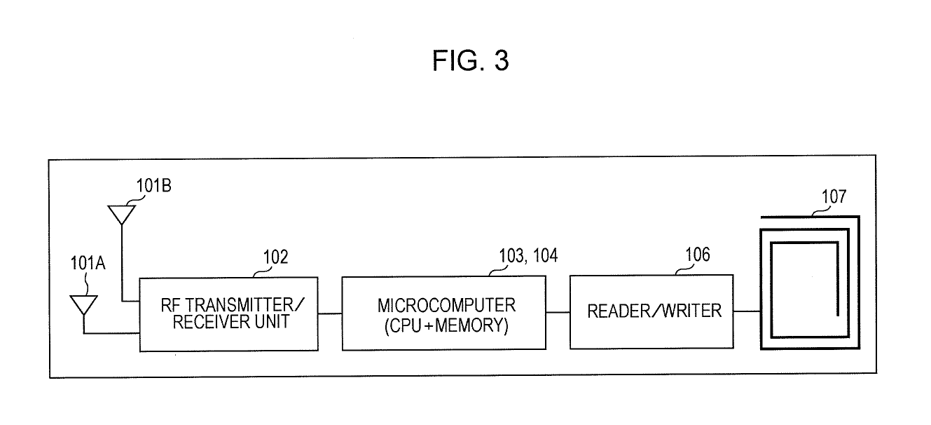

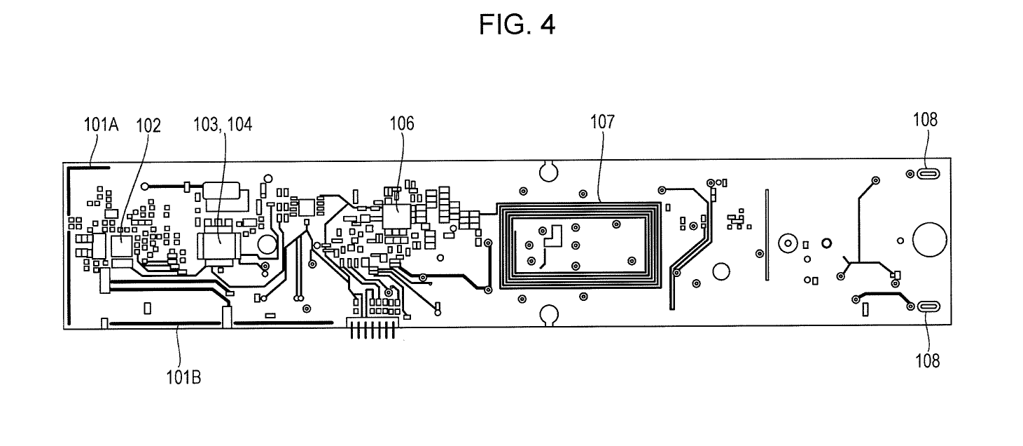

FIG. 3 schematically shows an arrangement of circuit modules 101 to 104, 106 and 107 on a surface A of the main board in the remote controller 100 of FIG. 2. Furthermore, FIG. 4 shows an example of circuit patterns on the surface A of the main board in FIG. 3. In this embodiment, the main board is a double-sided board, and the key operating unit 105 is mounted on the opposite surface B (not shown) of the main board. The details of the board structure will be described later. Moreover, although various circuit components in addition to the circuit modules 101 to 104, 106, and 107 are mounted on the surface A of the main board in FIG. 4, these components are not directly related to main points of the present disclosure. Therefore, a detailed description thereof will be omitted hereinafter.

The antenna 101 of the RF transmitter/receiver unit 102 employs a diversity system having a combination of two dipole antenna elements 101A and 101B. The dipole antenna element 101A is located on the edge of a short side of the board surface A and extends along this edge. The dipole antenna 101B is located on the edge of a long side of the board surface A close to the short side, and extends along this edge.

The dipole antenna elements 101A and 101B are each formed by connecting two conductors to the positive and negative electrodes of the power source. Each of the conductors is ¼ of the used wavelength λ in length. In other words, the total length of both conductors is equal to ½ of the used wavelength. If the wireless communication module including the antenna 101 and the RF transmitter/receiver unit 102 is mounted on a sub board as in a typical remote controller, then it is difficult to dispose the diversity antenna on such a small area. Alternatively, a chip antenna may be used instead of the diversity antenna. However, in this case, the sensitivity of transmission and reception is degraded. In contrast, when the wireless communication module is mounted on the main board as shown in FIG. 4, the diversity antenna can be provided at a low cost.

When balanced antenna lines such as dipole antenna elements are applied to the antenna 101, the antenna 101 becomes highly sensitive, and makes a balun unnecessary. In addition, usage of the diversity system improves the resistance to fading.

All ground patterns for the circuit portions handling high frequency signals are formed on the surface B of the main board. If it is difficult to sufficiently ensure an area for the ground patterns, it is preferable that balanced antenna patterns be formed as the antenna 101. Otherwise, if it is possible to secure this area, it is preferable that unbalanced antenna patterns be formed. The balanced antenna system is provided with larger antenna elements, but is made possible on a small ground area. Meanwhile, the unbalanced antenna system enables reduction in the size of antenna elements, but involves a greater ground area. In this embodiment, it is possible to ensure the area for the antenna elements on the surface A of the main board, but it is difficult to secure a wide ground area on the surface B thereof. In consideration of this fact, the balanced antenna system is employed.

The RF transmitter/receiver unit 102 mainly performs the process of the PHY/MAC layer in RF4CE, and the CPU 103 performs the processes of the layers higher than the MAC layer in the communication protocol. When the wireless communication module including the antenna 101 and the RF transmitter/receiver unit 102 is mounted on a sub board as in a typical remote controller, the circuit module for performing the processes of the layers higher than the MAC layer in the communication protocol is mounted on this sub board. In contrast, when the wireless communication module is mounted on the main board as shown in FIGS. 3 and 4, the CPU 103, or a single microcomputer chip implementing the functions of the CPU 103 and the memory 104, performs both the remote control operation and the processes of the layers higher than the MAC layer in the communication protocol. This enables cost reduction of the circuit.

The antenna 107 of the reader/writer 106 includes a loop antenna provided by forming a conductive pattern in a spiral shape. In addition, this antenna is formed near the center of the main board. When the contactless communication module is mounted on a sub board as in a typical remote controller, the sub board having the loop antenna thereon is typically located near the casing of the remote controller 100. This makes it possible to intensify the AC magnetic field at a card information reading portion on the surface of the casing, and in such a case, one loop of the antenna is sufficient for the function. In contrast, when the contactless communication module is mounted on the main board as shown in FIGS. 3 and 4, the antenna 107 is placed away from the card information reading portion on the surface of the casing. Accordingly, in order to generate an AC magnetic field of sufficient intensity at the card information reading portion, it becomes necessary for the antenna 107 to have approximately six loops.

As described above, both the wireless communication module and the contactless communication module are mounted on the surface A of the main board. In this case, the mounting density of the surface A becomes high. This leads to complexity of the wiring and routing design. Accordingly, all ground patterns for the circuit portions handling high frequency signals are formed on the surface B that is opposite the surface A of the main board, in order to reserve the mounting area on the surface A. In addition, a key matrix circuit of the key operating unit 105 is also mounted on the surface B.

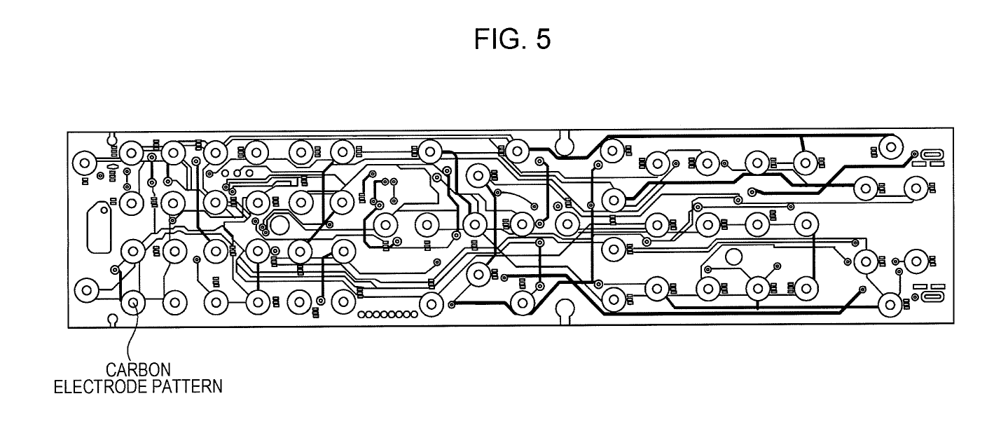

FIG. 5 shows an example of circuit patterns formed on the surface B of the main board. On the surface B, the key matrix circuit of the key operating unit 105, the ground patterns of the circuit portions handling high frequency signals, and carbon electrode patterns of switches are mounted. In the example shown in FIG. 5, the carbon electrode patterns on the uppermost layer are arranged regularly in accordance with the arrangement of the keys.

As described with reference to FIGS. 3 and 4, the antenna 101 and the RF transmitter/receiver unit 102 in the wireless communication module, a single microcomputer chip implementing the functions of the CPU 103 and the memory 104, the reader/writer 106 and the antenna 107 in the contactless communication module, and other circuit components are mounted on the surface A of the main board.

Meanwhile, the key matrix circuit of the key operating unit 105, the ground patterns for the circuit portions handling the high frequency signals, and the carbon electrode patterns of the switches are formed on the surface B of the main board. In addition, other patterns occupying a large area may be formed on the surface B. The ground patterns on the surface B may be limited to those for the circuit portions handling the high frequency signals.

Accordingly, the area of the main board is decreased and the two-layer structure of the main board is achieved.

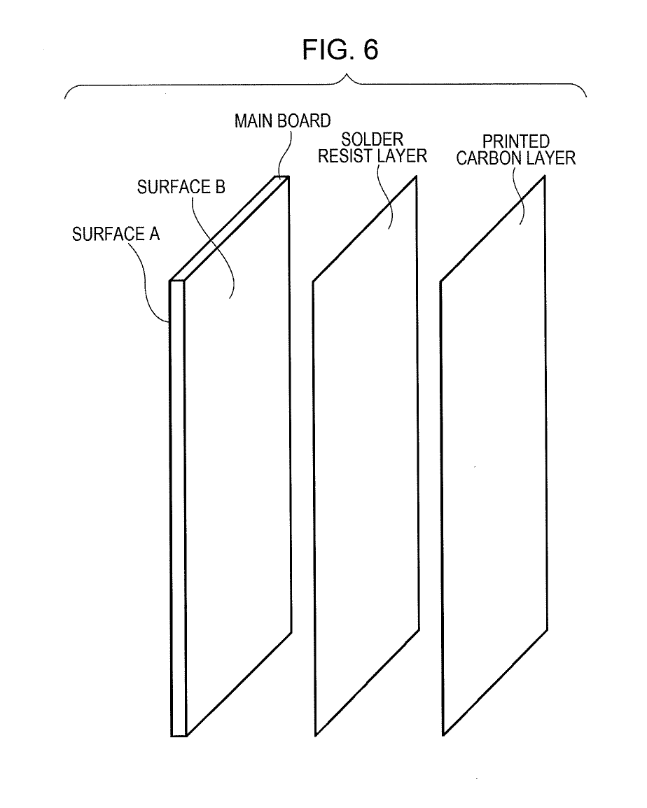

FIG. 6 schematically shows a sectional structure of the main board. In order to achieve high mounting density on the surface B, the board is fabricated by the following steps. First, the ground patterns and the key matrix circuit are formed on the surface B. Subsequently, a solder resistant layer is laminated thereon. Finally, the carbon electrode patterns (refer to FIG. 5) of the switches in the key operating unit 105 are formed thereon. With the surface B having a high mounting density, an area on the surface A on which the circuit components are to be mounted can be secured sufficiently, and the flexibility in layout of the antennas is increased. In the example shown in FIG. 4, the dipole or balanced antenna elements 101A and 101B occupying a large area are formed to constitute the diversity antenna system for wireless communications. Alternatively, unbalanced antenna elements such as inverted-F antenna elements may be formed. Furthermore, the spiral pattern of the loop antenna 107 in the contactless communication module is also formed on the surface A of the main board.

The embodiment of the present disclosure has been described. However, the present disclosure is not limited to the above-described embodiment. In this embodiment, the remote controller is applied to a remote operation device in a remote control system including a controlled object, namely, a host apparatus. However, this remote controller may be applied to any type of remote operation device in various wireless communication systems conducting two-way communication. Moreover, in this embodiment, the remote control system conducts communication in accordance with RF4CE specification. However, it should be noted that the communication scheme of the remote control system is not limited to a specific standardized specification.

The present disclosure contains subject matter related to that disclosed in Japanese Priority Patent Application JP 2011-004271 filed in the Japan Patent Office on Jan. 12, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A remote operation device comprising:
a main board housed in a casing of the remote operation device;
a wireless communication module disposed on a first surface of the main board, the wireless communication module including an antenna;
a control circuit disposed on the first surface of the main board, the control circuit performing a remote operation process through wireless communication;
at least one ground pattern disposed on a second surface of the main board; and
a matrix circuit of remote operation keys disposed on the second surface of the main board.

2. The remote operation device according to claim 1, further comprising a contactless communication module disposed on the first surface of the main board, the contactless communication module including an antenna.

3. The remote operation device according to claim 1,
wherein the antenna of the wireless communication module includes a balanced or unbalanced antenna made of at least one pattern formed on the first surface of the main board.

4. The remote operation device according to claim 1,
wherein the antenna of the wireless communication module is a diversity antenna including two dipole antenna elements made of patterns formed on the first surface of the main board.

5. The remote operation device according to claim 1,
wherein the control circuit performs both the remote operation process and a process of an upper protocol layer during the wireless communication conducted by the wireless communication module including the antenna.

6. The remote operation device according to claim 1,
wherein the ground pattern disposed on the second surface of the main board is limited to a ground pattern for a high frequency circuit portion of the wireless communication module.

7. The remote operation device according to claim 1,
wherein the main board includes, on the second surface, a solder resist layer and carbon electrode patterns for switches of the remote operation keys, and
wherein the solder resist layer is formed on the second surface of the main body on which the ground pattern and the matrix circuit of the remote operation keys are formed, and the carbon electrode patterns are formed on the solder resist layer.
